(19) United States
(12) Patent Application Publication
(10) Pub. No.: US 2024/0183208 A1
(43) Pub. Date: Jun. 6, 2024

(54) PULLEY MOUNTING STRUCTURE, SLIDE DOOR AND SHOWER ROOM

(71) Applicant: FUJIAN XIHE SANITARY WARE TECHNOLOGY CO., LTD, Fujian (CN)

(72) Inventors: Xiaofa LIN, Fujian (CN); Xiaoshan LIN, Fujian (CN); Xiaoqing DENG, Fujian (CN); Shengde YANG, Fujian (CN); Qiqiao LIU, Fujian (CN)

(73) Assignee: FUJIAN XIHE SANITARY WARE TECHNOLOGY CO., LTD, Fujian (CN)

(21) Appl. No.: 18/334,561

(22) Filed: Jun. 14, 2023

(30) Foreign Application Priority Data
Dec. 1, 2022 (CN) 202211536502.7

(51) Int. Cl. E05D 15/06

(52) U.S. Cl. CPC E05D 15/063; E05Y 2600/46; E05Y 2600/51; E05Y 2600/61; E05Y 2600/624; E05Y 2600/632; E05Y 2600/636; E05Y 2900/114

(57) ABSTRACT

A pulley mounting structure includes a pulley assembly and a slide rail which has a top part, a bottom part and an opening between the top part and the bottom part; the pulley assembly includes a support body and a pulley rotationally mounted to the support body, the pulley is inserted into the slide rail through the opening and in sliding fit with the bottom part of the slide rail; the support body has a limit part, and is configured to be rotatable from an initial mounting position to a working position relative to the slide rail around a central axis of the pulley, so that the limit part can at least partially enter into the slide rail in the initial mounting position and rotate to face the top part in the working position, the limit part is configured to abut against the top part in the working position.

### CROSS-REFERENCE TO RELATED APPLICATION(S)

This application claims foreign priority benefits under 35 U.S.C. § 119(a)-(d) to Chinese Patent Application No. 202211536502.7, filed on Dec. 1, 2022, which is hereby incorporated herein by reference in its entirety.

### TECHNICAL FIELD

The present application relates to, but is not limited to, pulley technology, in particular to a pulley mounting structure, a slide door, and a shower room.

### BACKGROUND

At present, in the mounting of a glass door of a bathroom, a pulley is mounted on the glass door, and the pulley is located in a slide rail to realize slidable opening and closing of the glass door.

In order to facilitate the mounting of the pulley in the slide rail, a relatively large opening is usually provided at a certain position of the slide rail, and the pulley is placed in the slide rail through the opening. However, such manner will destroy the integrity of the slide rail and degrade the aesthetics of the slide rail.

### SUMMARY

Embodiments of the present application provide a pulley mounting structure, a slide door and a shower room, which can slide smoothly and does not need to provide an additional mounting opening or notch on the sliding rail.

Embodiments of the present application provide a pulley mounting structure including a pulley assembly and a slide rail, the slide rail has a top part, a bottom part, and an opening between the top part and the bottom part; the pulley assembly includes a support body and a pulley, the pulley is rotationally mounted on the support body, the pulley is inserted into the slide rail through the opening and in sliding fit with the bottom part of the slide rail;

the support body is provided with a limit part, the support body is configured to be rotatable from an initial mounting position to a working position relative to the slide rail around a central axis of the pulley, so that the limit part can at least partially enter the slide rail in the initial mounting position and be rotated to face the top part of the slide rail in the working position, the limit part is configured to be able to abut against the top part of the slide rail in the working position to restrict the pulley from disengaging from the opening of the slide rail.

Further, the support body and the pulley are arranged side by side along the central axis of the pulley, the support body includes a mounting part, and the limit part is disposed at an end face of the mounting part facing the pulley.

Further, the limit part includes a limit plate, a first end of the limit plate is fixed to an end face of the mounting part, and a second end of the limit plate extends along a radial direction of the pulley and protrudes from an outer peripheral surface of the mounting part.

Further, the limit part further includes an elastic member, which is disposed on the limit plate and is configured to be able to abut against the top part of the slide rail to limit the pulley from disengaging from the opening of the slide rail.

Further, the limit plate is provided with a support boss extending along an axial direction of the pulley, and the elastic member is fixed to the support boss.

The elastic member is at least partially located in the slide rail, and the second end of the limit plate is at least partially located outside the slide rail.

Further, the limit plate and the support boss form a mounting region for mounting the elastic member. The elastic member is flush with the second end of the limit plate or protrudes from the second end of the limit plate.

Further, one of the elastic member and the support boss is provided with at least one limit protrusion, and the other of the elastic member and the support boss is correspondingly provided with at least one limit groove, and the limit protrusion is in interference fit with the limit groove to fix the elastic member to the support boss.

Further, the mounting part is cylindrical, and the limit part extends along the radial direction of the pulley and protrudes from the mounting part.

Further, the support body is provided with a rotation operation portion, which is provided for a screwing tool to drive the support body to rotate from the initial mounting position to the working position.

Further, the pulley assembly further includes a fixation member, and the support body includes a mounting part and a connection post connected with the mounting part, one end of the connection post is fixed on the mounting part, and the other end of the connection post extends along the axial direction of the pulley and toward a side facing away from the pulley;

the fixation member is sleeved on the connection post and connected with the connection post to clamp a mounting carrier between the mounting part and the fixation member;

wherein an axial end face of the connection post is provided with a first rotation hole, the first rotation hole is disposed for inserting a screwing tool to drive the support body to rotate, and the rotation operation portion includes the first rotation hole; and/or, an outer peripheral surface of the mounting part is provided with a second rotation hole, the second rotation hole is disposed for inserting a screwing tool to drive the support body to rotate, and the rotation operation portion includes the second rotation hole.

Further, in the working position, there is a gap between the limit part and the top part of the slide rail, so that the limit part abuts against the top part of the slide rail and is limited by the top part of the slide rail after the pulley assembly moves upward by a predefined distance.

Further, in the working position, a distance between a lowest point of the pulley and a highest point of the limit part is larger than a height of the opening of the slide rail.

Further, the bottom part of the slide rail is provided with a first inclined surface and a second inclined surface, and the first inclined surface and the second inclined surface form a V-shaped groove for accommodating a bottom part of the pulley; and the bottom part of the slide rail is further provided with an accommodation groove communicated with a bottom part of the V-shaped groove.

Further, the first inclined surface is located at a side of the pulley away from the opening, and the second inclined surface is located at a side of the pulley close to the opening; and a height of the second inclined surface is larger than a height of the first inclined surface, and/or a limit strip extending upward along a height direction is provided at a vertex position of the second inclined surface.

An embodiment of the present application further provides a slide door, which includes a slide door body and the pulley mounting structure described above, and the support body is mounted on the slide door body.

An embodiment of the present application further provides a shower room, which includes the slide door described above.

Compared with some techniques, the present application has the following beneficial effects:
in the pulley mounting structure according to the embodiment of the present application, the pulley assembly can be mounted into the slide rail by rotating the support body, and the limiting is formed after the mounting is completed, so as to prevent the pulley assembly from disengaging from the slide rail, without independently providing a relatively large mounting opening on the slide rail, thus protecting an integrity of the slide rail. In addition, the pulley assembly is more conveniently mounted in the guide rail, and the mounting process is simplified without “aligning the pulley assembly with the mounting opening” in the prior art, and the limiting can be completed by rotating the support body through tools such as wrenches after mounting, the operation is simple and quick.

The slide door according to the embodiment of the present application has the pulley mounting structure described above, which is convenient and quick to mount and slide smoothly.

The shower room according to the embodiment of the present application has the slide door described above, which has good use effect and high user satisfaction.

Other features and advantages of the present application will be set forth in the following description.

### BRIEF DESCRIPTION OF THE DRAWINGS

Accompanying drawings are used to provide a further understanding of the technical solution of the present application, and constitute a part of the description. They are used together with the embodiments of the present application to explain the technical solution of the present application, and do not constitute a restriction on the technical solution of the present application.

FIG. 1 is a first schematic diagram of a pulley mounting structure according to an embodiment of the present disclosure.

FIG. 2 is an enlarged view of a structure at part A in FIG. 1.

FIG. 3 is a second schematic diagram of a pulley mounting structure according to an embodiment of the present disclosure.

FIG. 4 is an enlarged view of a structure at part B in FIG. 3.

FIG. 5 is a schematic diagram of an exploded structure of a pulley mounting structure according to an embodiment of the present disclosure.

FIG. 6 is a third schematic diagram of a pulley mounting structure according to an embodiment of the present disclosure (a support body is in an initial mounting position).

FIG. 7 is a fourth schematic diagram of a pulley mounting structure according to an embodiment of the present disclosure (a support body is in a working position).

### ILLUSTRATION OF NUMERAL SIGNS

1-pulley assembly, 11-support body, 111-mounting part, 112-limit part, 1121-limit plate, 1122-support boss, 1123-limit groove, 1124-elastic member, 1125-limit protrusion, 113-connection post, 1131-first rotation hole, 114-second rotation hole, 12-pulley, 13-fixation member, 14-rubber pad, 15-decorative cover, 16-adjustment eccentric sleeve, 17-countersunk head screw, 2-slide rail, 21-top part, 22-opening, 23-bottom part, 231-first inclined surface, 232-second inclined surface, 233-limit strip, 234-accommodation groove, 24-gap, 3-slide door body, 4-screwing tool.

### DETAILED DESCRIPTION

In order to make object, technical solution and advantages of the present application clearer, the embodiments of the present application will be described in detail below with reference to the accompanying drawings. It is to be noted that the embodiments in the present application and the features in the embodiments may be combined with each other randomly if there is no conflict.

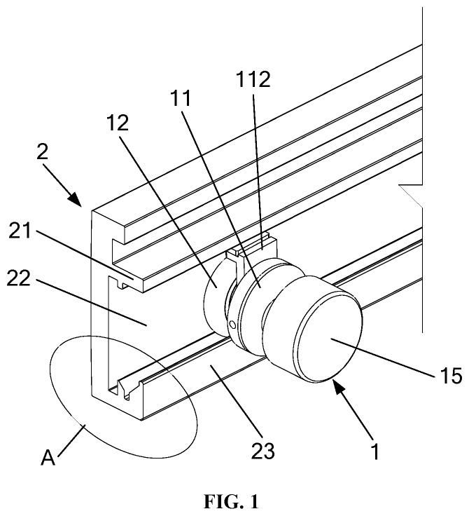

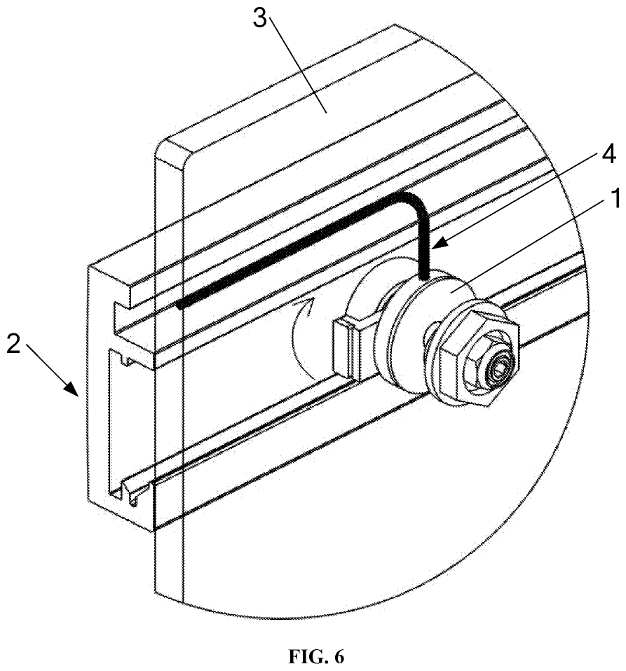

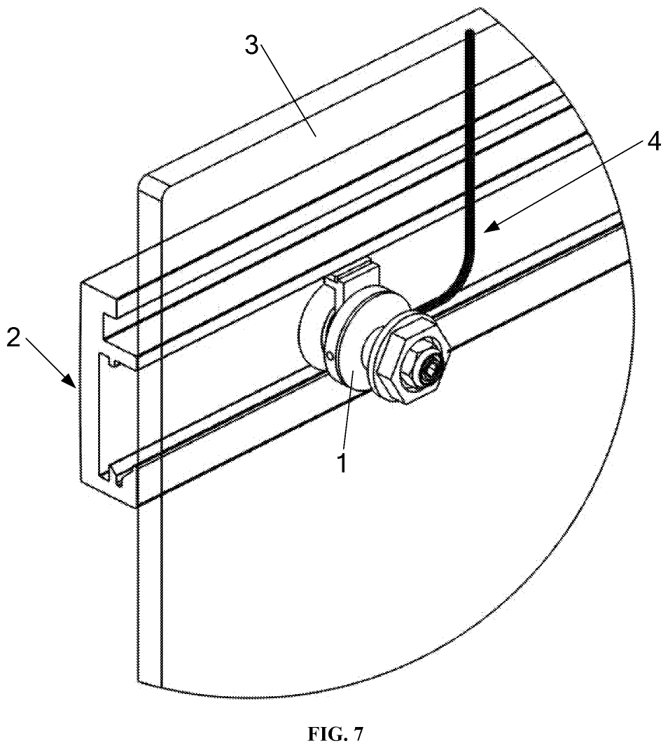

An embodiment of the present application provides a pulley mounting structure, as shown in FIG. 1 to FIG. 7, the pulley mounting structure includes a pulley assembly 1 and a slide rail 2. The slide rail 2 has a top part 21, a bottom part 23 and an opening 22 between the top part 21 and the bottom part 23. The pulley assembly 1 includes a support body 11 and a pulley 12, the pulley 12 is rotationally mounted to the support body 11, and the pulley 12 is inserted into the slide rail 2 through the opening 22 and is in sliding fit with the bottom part 23 of the slide rail 2. The support body 11 is provided with a limit part 112, the support body 11 is configured to be rotatable from an initial mounting position to a working position relative to the slide rail 2 around a central axis of the pulley 12, so that the limit part 112 can at least partially enter into the slide rail 2 in the initial mounting position and be rotated to face the top part 21 of the slide rail 2 in the working position. The limit part 112 is configured to abut against the top part 21 of the slide rail 2 in the working position to restrict the pulley 12 from disengaging from the opening 22 of the slide rail 2.

The opening 22 of the slide rail 2 is horizontally arranged, and the pulley 12 is mounted into the slide rail 2 along a horizontal direction. The pulley 12 abuts against the bottom part 23 of the slide rail 2 for the sliding fit. The pulley 12 is located in the slide rail 2, and the support body 11 is partially located in the slide rail 2.

The support body 11 is mounted on the slide door body 3. In a mounting process, the support body 11 is in the initial mounting position, the pulley 12 is mounted into the slide rail 2, and then the support body 11 is rotated to the working position, so that the limit part 112 is fitted with the top part 21 of the slide rail 2 to restrict the pulley 12 from disengaging from the opening 22 of the slide rail 2, while ensuring that the pulley 12 can slide smoothly in the slide rail 2.

In other words, when the support body 11 is in the initial mounting position, the pulley 12 can be mounted into the slide rail 2, and when the support body 11 is in the working position, the pulley 12 cannot be mounted into the slide rail 2, and the pulley 12 can be prevented from disengaging from the slide rail 2 when the support body 11 is in the working position.

The pulley 12 is rotatably mounted on the support body 11 by a countersunk head screw 17 or a screw.

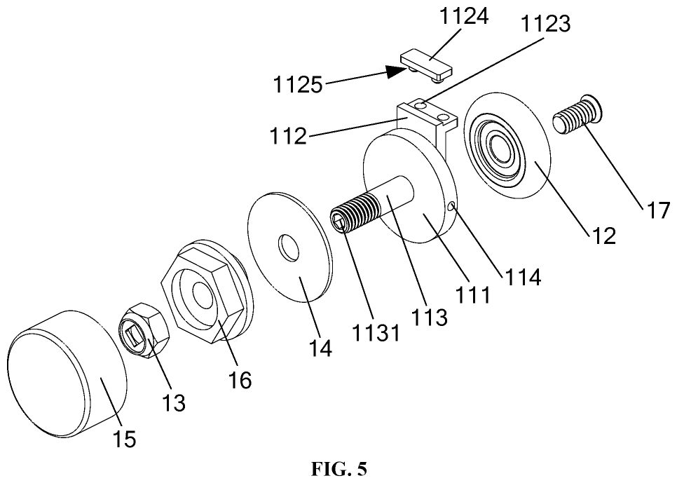

In an exemplary embodiment, as shown in FIG. 1 and FIG. 5, the support body 11 and the pulley 12 are arranged side by side along a central axis of the pulley 12, the support body 11 includes a mounting part 111, and a limit part 112 is disposed at an end face of the mounting part 111 facing the pulley 12.

The support body 11 includes a mounting part 111 and a limit part 112. The limit part 112 is disposed on the mounting part 111. The mounting part 111 serves as a mounting body structure and the mounting part 111 rotates together with the limit part 112, so that the limit part 112 rotates to face the top part 21 of the slide rail 2 to achieve a limiting effect. The mounting part 111 may be a cylindrical member.

The limit part 112 is disposed at an end face of the mounting part 111 facing the pulley 12, so that when the pulley 12 is mounted into the slide rail 2, the limit part 112 can also enter the slide rail 2, and the limit part 112 can face the top part 21 of the slide rail 2 by being rotated subsequently, thereby realizing the limiting.

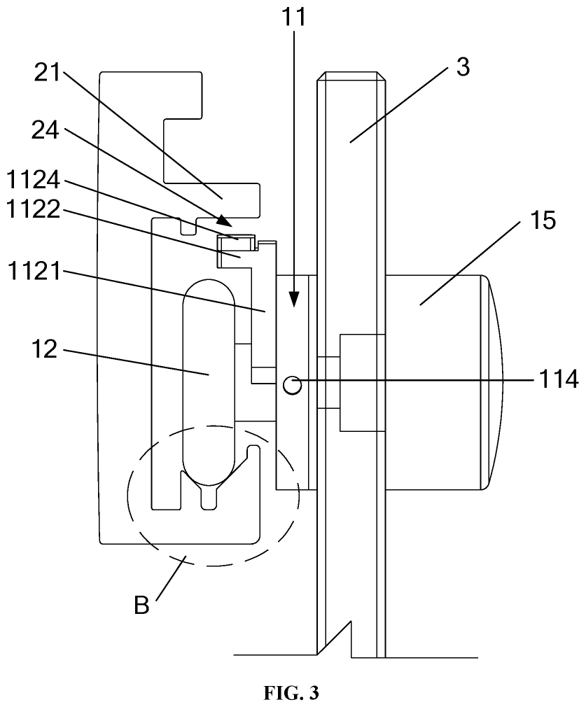

In an exemplary embodiment, as shown in FIG. 3, the limit part 112 includes a limit plate 1121, a first end of the limit plate 1121 is fixed to the end face of the mounting part 111, and a second end of the limit plate 1121 extends along a radial direction of the pulley 12 and protrudes from an outer peripheral surface of the mounting part 111.

The limit part 112 may include a rectangular limit plate 1121. The limit plate 1121 extends along the radial direction of the pulley 12 and protrudes from the outer peripheral surface of the mounting part 111 so as to be rotated to face the top part 21 of the slide rail 2 after being mounted into the slide rail 2.

The second end of the limit plate 1121 protrudes from the outer peripheral surface of the mounting part 111, that is, after the support body 11 is rotated to the working position, the second end of the limit plate 1121 is higher than a vertex position of the pulley 12, so as to ensure that the pulley 12 does not collide or rub against the top part 21 of the slide rail 2 while the limit plate 1121 is fitted with the top part 21 of the slide rail 2 for limiting.

In an exemplary embodiment, as shown in FIG. 3 and FIG. 5, the limit part 112 further includes an elastic member 1124, and the elastic member 1124 is disposed on the limit plate 1121 and configured to abut against the top part 21 of the slide rail 2 to restrict the pulley 12 from disengaging from the opening 22 of the slide rail 2.

The elastic member 1124 may be a rubber pad 14.

The elastic member 1124 is disposed at the second end of the limit plate 1121 to avoid violent collision when the limit part 112 and the top part 21 of the slide rail 2 abut against each other to achieve the limit effect. The elastic member 1124 has a buffer effect, which reduces the impact force generated during collision, improves hand feeling of users when closing or opening the door, and avoids complaints from users caused by bumping during sliding. By providing the elastic member 1124, the slide rail 2 can be prevented from being scratched when the limit part 112 is in contact with the top part 21 of the slide rail 2, thereby achieving an effect of protecting the slide rail 2.

In an exemplary embodiment, as shown in FIG. 3, the limit plate 1121 is provided with a support boss 1122 extending axially along the pulley 12, and the elastic member 1124 is fixed to the support boss 1122. The elastic member 1124 is at least partially located inside the slide rail 2, and the second end of the limit plate 1121 is at least partially located outside the slide rail 2.

The second end of the limit plate 1121 is provided with a support boss 1122 extending along an axial direction of the pulley 12 and the support boss 1122 serves as a mounting structure for the elastic member 1124.

The elastic member 1124 is at least partially located in the slide rail 2, and the second end of the limit plate 1121 is at least partially located outside the slide rail 2. In other words, the elastic member 1124 is partially located in the slide rail 2 to serve the functions of limiting, buffering and the like, and the second end of the limit plate 1121 is partially located outside the slide rail 2 to ensure that there is no interference between the limit plate 1121 and the slide rail 2.

In an exemplary embodiment, as shown in FIG. 3 and FIG. 5, the limit plate 1121 and the support boss 1122 form a mounting region for mounting the elastic member 1124, the mounting region faces the top part 21 of the slide rail. The elastic member 1124 is flush with or protrudes from the second end of the limit plate 1121.

The limit plate 1121 and the support boss 1122 form the mounting region for mounting the elastic member 1124, and the mounting region faces the top part 21 of the slide rail, so that the mounted elastic member 1124 is positioned between the top part 21 of the slide rail and the support boss 1122. The elastic member 1124 is mounted at the second end of the limit plate 1121, and the limit plate 1121 can limit the elastic member 1124 to some extent in the axial direction of the pulley 12 to prevent the elastic member 1124 from shifting along the axial direction during collision. The limit plate 1121 also shields the elastic member 1124 to some extent to prevent outside members from touching and damaging the elastic member 1124.

The elastic member 1124 is flush with the second end of the limit plate 1121, or the elastic member 1124 protrudes from the second end of the limit plate 1121. A specific size of the limit plate 1121 can be adjusted according to actual needs, which is not limited in the present application.

In an exemplary embodiment, one of the elastic member 1124 and the support boss 1122 is provided with at least one limit protrusion 1125, and the other of the elastic member 1124 and the support boss 1122 is correspondingly provided with at least one limit groove 1123, and the limit protrusion 1125 is in interference fit with the limit groove 1123 so as to fix the elastic member 1124 to the support boss 1122.

As shown in FIG. 5, a lower surface of the elastic member 1124 is provided with two limit protrusions 1125, and two limit grooves 1123 are correspondingly provided on the support boss 1122. The limit protrusions 1125 are in interference fit with the limit grooves 1123, so that the elastic member 1124 is fixed to the support boss 1122. The manner of fitting between the limit protrusions 1125 and the limit grooves 1123 facilitates replacement of the elastic member 1124 in a later stage, reduces the use cost of the pulley mounting structure, and prolongs a service life of the whole pulley mounting structure.

Obviously, the elastic member 1124 and the support boss 1122 can be connected by other means, for example, the elastic member 1124 is fixed to the support boss 1122 by adhesive.

In an exemplary embodiment, as shown in FIG. 5, the mounting part 111 is cylindrical and the limit part 112 extends along the radial direction of the pulley 12 and protrudes from the mounting part 111.

The limit part 112 extends along the radial direction of the pulley 12 (a radial direction of the mounting part 111) and protrudes from the mounting part 111. Upon mounting (i.e., when the support body 11 is in the initial mounting position), an extension direction of the limit part 112 is parallel to a length direction of the opening 22 of the slide rail 2, so that the pulley assembly 1 is mounted into the slide rail 2, and the limit part 112 does not act as an obstruction.

When the support body 11 is rotated to the working position, the extension direction of the limit part 112 after rotation is perpendicular to the length direction of the opening 22 of the slide rail 2, and the limit part 112 serves a disengagement prevention function to prevent the pulley 12 from being disengaged from the opening 22 of the slide rail 2.

The limit part 112 protrudes from the mounting part 111, which facilitates the limiting after rotation, eliminates the need of other complicated structures, and effectively simplifies the overall structure.

In an exemplary embodiment, the support body 11 is provided with a rotation operation portion which is provided for a screwing tool 4 to drive the support body 11 to rotate from the initial mounting position to the working position.

The rotation operation portion is disposed on the support body 11, and an operator controls the rotation operation portion by screwing the tool 4 to rotate the support body 11.

In an exemplary embodiment, as shown in FIG. 5, the pulley assembly 1 further includes a fixation member 13, and the support body 11 includes the mounting part 111 and a connection post 113 connected with the mounting part 111. One end of the connection post 113 is fixed to the mounting part 111, and the other end of the connection post 113 extends along the axial direction of the pulley 12 and toward a side facing away from the pulley 12. The fixation member 13 is sleeved on the connection post 113 and connected to the connection post 113 so as to sandwich a mounting carrier between the mounting part 111 and the fixation member 13. An axial end face of the connection post 113 is provided with a first rotation hole 1131, the first rotation hole 1131 is provided for inserting the screwing tool 4 to drive the support body 11 to rotate, and the rotation operation portion includes the first rotation hole 1131; and/or, a second rotation hole 114 is provided on the outer peripheral surface of the mounting part 111, the second rotation hole 114 is provided for inserting the screwing tool 4 to drive the support body 11 to rotate, and the rotation operation portion includes the second rotation hole 114.

The fixation member 13 may be a nut.

A through hole is provided in the mounting carrier (e.g., a glass door), the connection post 113 penetrates through the through hole in the mounting carrier, and the fixation member 13 is sleeved at the end of the connection post 113 to mount the pulley assembly 1 to the mounting carrier.

In actual operation, a rubber pad 14 may be sleeved on the connection post 113 to ensure that the mounting carrier and the support body 11 are firmly fixed. An adjustment eccentric sleeve 16 may also be provided at the fixation member 13 to adjust a gap between the mounting carrier and a wall surface perpendicular to the mounting carrier.

The first rotation hole 1131 is provided on the axial end face of the connection post 113. After the screwing tool 4 is inserted into the first rotation hole 1131, the screwing tool 4 is fitted with the first rotation hole 1131, and an operator can rotate the support body 11 by rotating the screwing tool 4. The second rotation hole 114 is provided on the outer peripheral surface of the mounting part 111. After the screwing tool 4 is inserted into the second rotation hole 114, the screwing tool 4 is fitted with the second rotation hole 114, and an operator can rotate the support body 11 by rotating the screwing tool 4.

The first rotation hole 1131 may be a hexagon hole and the screwing tool 4 may be a hexagon wrench. The second rotation hole 114 may be a hexagonal hole or another form of through hole.

Specifically, the fitting between the first rotation hole 1131 and the screwing tool 4 is realized by inserting the screwing tool 4 with a hexagonal cross section (i.e., an internal hexagonal wrench) into a hexagonal hole, so that the screwing tool 4 is fitted with the first rotation hole 1131 to drive the support body 11 to rotate, and the operation is convenient. The manner of fitting between the second rotation hole 114 and the screwing tool 4 is different from that at the first rotation hole 1131. The screwing tool 4 is inserted into the second rotation hole 114 along the radial direction of the support body 11. A cross-sectional shape of the screwing tool 4 does not need to be identical to a shape of the second rotation hole 114, but only needs to ensure that the screwing tool 4 can be normally inserted into the second rotation hole 114. The screwing tool 4 is inserted into the second rotation hole 114 to directly push the support body 11 to rotate, and the operation is more reliable.

That is, the first rotation hole 1131 on the axial end face of the connection post 113 is provided at a position that facilitates insertion of the screwing tool 4, facilitates operation by an operator, and can be used as a main rotation operation portion. The second rotation hole 114 located on the outer peripheral surface of the mounting part 111 serves as a spare rotation operation portion, and may serve as a spare if the first rotation hole 1131 is damaged.

In an exemplary embodiment, as shown in FIG. 3, in the working position, there is a gap 24 between the limit part 112 and the top part 21 of the slide rail 2, so that the limit part 112 abuts against the top part 21 of the slide rail 2 and is restricted by the top part 21 of the slide rail 2 after the pulley assembly 1 is moved upward by a predefined distance.

There is the gap 24 between the limit part 112 and the top part 21 of the slide rail 2. The gap 24 can ensure that the limit part 112 does not rub against the top part 21 of the slide rail 2 during a normal sliding process of the pulley assembly 1 in the slide rail 2, thus avoiding affecting the normal sliding of the pulley assembly 1.

When the pulley 12 is likely to fall off due to bumping or the like, the pulley assembly 1 is moved upwards, and the limit part 112 abuts against the top part 21 of the slide rail 2 and is limited to prevent the pulley 12 from disengaging from the slide rail 2. A range of the gap 24 may be 1-3 mm, for example, the gap 24 may be 2 mm.

In an exemplary embodiment, a distance between a lowest point of the pulley 12 and a highest point of the limit part 112 is greater than a height of the opening 22 of the slide rail 2 in the working position.

The distance between the lowest point of the pulley 12 and the highest point of the limit part 112 is larger than the height of the opening 22 of the slide rail 2, so that the limit part 112 can abut against the top part 21 of the slide rail 2 when being bumped to move upwards, thus effectively preventing the pulley 12 from being disengaged from the opening 22 of the slide rail 2.

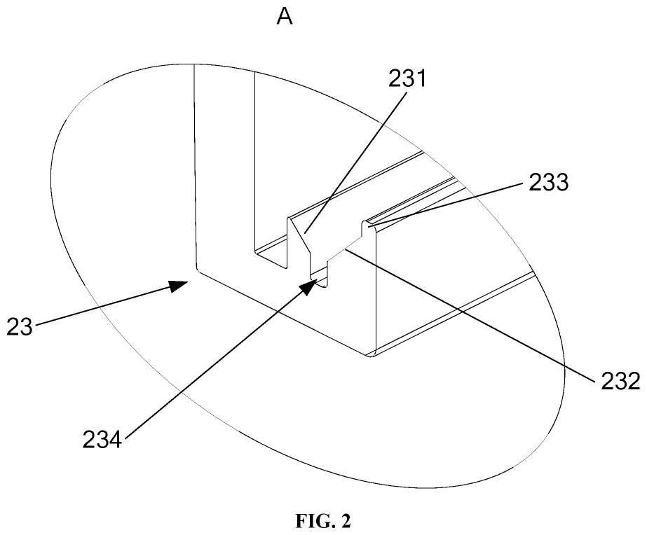

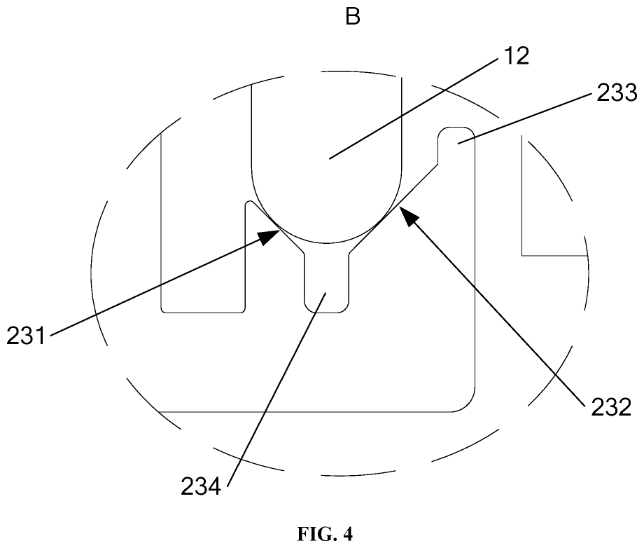

In an exemplary embodiment, as shown in FIG. 2 and FIG. 4, the bottom part 23 of the slide rail 2 is provided with a first inclined surface 231 and a second inclined surface 232. The first inclined surface 231 and the second inclined surface 232 form a V-shaped groove for accommodating a bottom part of the pulley 12. The bottom part 23 of the slide rail 2 is further provided with an accommodation groove 234 communicated with a bottom part 23 of the V-shaped groove.

The V-shaped groove formed by the first inclined surface 231 and the second inclined surface 232 can ensure that the pulley 12 slides stably in the slide rail 2 without left and right deviation.

The bottom part 23 of the slide rail 2 is provided with the accommodation groove 234 communicated with the V-shaped groove. In daily use, dust or other impurities will fall into the accommodation groove 234 after entering the slide rail 2 without being accumulated in the V-shaped groove, so as to avoid dust accumulation affecting the normal sliding of the pulley 12.

In an exemplary embodiment, as shown in FIG. 2 and FIG. 4, the first inclined surface 231 is located at a side of the pulley 12 away from the opening 22, and the second inclined surface 232 is located at a side of the pulley 12 close to the opening 22. A height of the second inclined surface 232 is greater than that of the first inclined surface 231, and/or a limit strip 233 extending upward along the height direction is provided at a vertex position of the second inclined surface 232.

The second inclined surface 232 limits the pulley 12 through the higher height and the limit strip 233, so that the pulley 12 will not pass across the second inclined surface 232 before the pulley 12 moves upwards due to bumping and the limit part 112 abuts against the top part 21 of the slide rail 2, thus ensuring that the pulley 12 will not be disengaged from the slide rail 2.

In actual use, the pulley mounting structure may further include a decorative cover 15, and the decorative cover 15 covers and is mounted on one end of the support body 11 provided with the fixation member 13, so as to shield the support body 11 and the fixation member 13, prevent external dust or foreign matter from scraping, and improve the overall aesthetics of the pulley mounting structure.

An embodiment of the present application further provides a slide door, and the slide door includes a slide door body 3 and the pulley mounting structure described above, and the support body 11 is mounted on the slide door body 3. The slide door body 3 serves as the mounting carrier mentioned above.

The smooth sliding of the slide door body 3 is implemented through the pulley mounting structure.

It should be noted that, during use, the slide door can be fitted with other members, such as a fixing structure disposed on the slide door body 3, which keeps the slide door body 3 in a vertical state, so that the pulley 12 is normally fitted with the slide rail 2 for sliding.

An embodiment of the present application also provides a shower room, which includes the slide door described above.

The shower room according to the embodiment of the present application has the slide door described above, which has good use effect and high user satisfaction.

In the description of the present disclosure, it should be noted that the orientation or position relationships indicated by the terms “upper”, “lower”, “one end”, “one side” and the like are based on the orientation or position relationships shown in the drawings, which are only for convenience of describing the present application and simplifying the description, rather than indicating or implying that the referred structure has the specific orientation, is constructed and operated in the specific orientation, and thus cannot be interpreted as a limitation on the present application.

In the description of the embodiments of the present disclosure, unless otherwise explicitly specified and limited, the terms “connection”, “assembly”, “mounting” should be understood in a broad sense, for example, the term “connection” may be fixed connection, detachable connection or integrated connection; it may be direct connection, or indirect connection through an intermediary, or may be an internal communication between two elements. For those of ordinary skills in the art, specific meanings of the above terms in the present application can be understood according to specific situations.

The embodiments described in the present application are exemplary but not restrictive, and it will be apparent to those of ordinary skills in the art that more embodiments and implementations may be included within the scope of the embodiments described herein. Although many possible combinations of features are shown in the drawings and discussed in the specific embodiments, many other combinations of the disclosed features are also possible. Unless purposely limited, any feature or element of any embodiment may be used in conjunction with or in place of any other feature or element of any other embodiment.

The present application includes and contemplates combinations of features and elements known to those of ordinary skills in the art. The embodiments, features and elements already disclosed in the present disclosure may also be combined with any conventional feature or element to form a unique technical solution defined by the claims. Any feature or element of any embodiment may also be combined with features or elements from other technical solutions to form another unique technical solution defined by the claims. Accordingly, it should be understood that any of the features shown and/or discussed in the present application may be implemented alone or in any suitable combination. Thus, the embodiments are not subject to limitations other than those made in accordance with the appended claims and their equivalent substitutions. In addition, various modifications and changes can be made within the protection scope of the appended claims.

1. A pulley mounting structure, comprising a pulley assembly and a slide rail, wherein the slide rail has a top part, a bottom part, and an opening between the top part and the bottom part; the pulley assembly comprises a support body and a pulley, the pulley is rotationally mounted on the support body, the pulley is inserted into the slide rail through the opening and in sliding fit with the bottom part of the slide rail;
the support body is provided with a limit part, the support body is configured to be rotatable from an initial mounting position to a working position relative to the slide rail around a central axis of the pulley, so that the limit part is able to at least partially enter the slide rail in the initial mounting position and be rotated to face the top part of the slide rail in the working position, the limit part is configured to be able to abut against the top part of the slide rail in the working position to restrict the pulley from disengaging from the opening of the slide rail.

2. The pulley mounting structure according to claim 1, wherein the support body and the pulley are arranged side by side along the central axis of the pulley, the support body comprises a mounting part, and the limit part is disposed at an end face of the mounting part facing the pulley.

3. The pulley mounting structure according to claim 2, wherein the limit part comprises a limit plate, a first end of the limit plate is fixed to the end face of the mounting part, and a second end of the limit plate extends along a radial direction of the pulley and protrudes from an outer peripheral surface of the mounting part.

4. The pulley mounting structure according to claim 3, wherein the limit part further comprises an elastic member disposed on the limit plate and configured to be able to abut against the top part of the slide rail to limit the pulley from disengaging from the opening of the slide rail.

5. The pulley mounting structure according to claim 4, wherein the limit plate is provided with a support boss extending along an axial direction of the pulley, and the elastic member is fixed to the support boss; and
the elastic member is at least partially located in the slide rail, and the second end of the limit plate is at least partially located outside the slide rail.

6. The pulley mounting structure according to claim 5, wherein the limit plate and the support boss form a mounting region for mounting the elastic member; and
the elastic member is flush with the second end of the limit plate or protrudes from the second end of the limit plate.

7. The pulley mounting structure according to claim 5, wherein one of the elastic member and the support boss is provided with at least one limit protrusion, and the other of the elastic member and the support boss is correspondingly provided with at least one limit groove, and the limit protrusion is in interference fit with the limit groove to fix the elastic member to the support boss.

8. The pulley mounting structure according to claim 2, wherein the mounting part is cylindrical, and the limit part extends along a radial direction of the pulley and protrudes from the mounting part.

9. The pulley mounting structure according to claim 1, wherein the support body is provided with a rotation operation portion, the rotation operation portion is provided for a screwing tool to drive the support body to rotate from the initial mounting position to the working position.

10. The pulley mounting structure according to claim 9, wherein the pulley assembly further comprises a fixation member, and the support body comprises a mounting part and a connection post connected with the mounting part, one end of the connection post is fixed on the mounting part, and the other end of the connection post extends along an axial direction of the pulley and toward a side facing away from the pulley;
the fixation member is sleeved on the connection post and connected with the connection post to sandwich a mounting carrier between the mounting part and the fixation member;
wherein an axial end face of the connection post is provided with a first rotation hole, and the first rotation hole is disposed for inserting a screwing tool to drive the support body to rotate, and the rotation operation portion comprises the first rotation hole; and/or
an outer peripheral surface of the mounting part is provided with a second rotation hole, and the second rotation hole is disposed for inserting a screwing tool to drive the support body to rotate, and the rotation operation portion comprises the second rotation hole.

11. The pulley mounting structure according to claim 1, wherein in the working position, there is a gap between the limit part and the top part of the slide rail, so that the limit part abuts against the top part of the slide rail and is limited by the top part of the slide rail after the pulley assembly moves upward by a predefined distance.

12. The pulley mounting structure according to claim 1, wherein in the working position, a distance between a lowest point of the pulley and a highest point of the limit part is larger than a height of the opening of the slide rail.

13. The pulley mounting structure according to claim 1, wherein the bottom part of the slide rail is provided with a first inclined surface and a second inclined surface, and the first inclined surface and the second inclined surface form a V-shaped groove for accommodating a bottom part of the pulley; and
the bottom part of the slide rail is further provided with an accommodation groove communicated with a bottom part of the V-shaped groove.

14. The pulley mounting structure according to claim 13, wherein the first inclined surface is located at a side of the pulley away from the opening, and the second inclined surface is located at a side of the pulley close to the opening; and
a height of the second inclined surface is larger than a height of the first inclined surface, and/or a limit strip extending upward along a height direction is provided at a vertex position of the second inclined surface.

15. A slide door, comprising a slide door body and the pulley mounting structure according to claim 1, wherein the support body is mounted on the slide door body.

16. A shower room, comprising the slide door according to claim 15.

17. The pulley mounting structure according to claim 3, wherein the mounting part is cylindrical, and the limit part extends along a radial direction of the pulley and protrudes from the mounting part.

18. The pulley mounting structure according to claim 2, wherein the support body is provided with a rotation operation portion, the rotation operation portion is provided for a screwing tool to drive the support body to rotate from the initial mounting position to the working position.

19. The pulley mounting structure according to claim 2, wherein in the working position, a distance between a lowest point of the pulley and a highest point of the limit part is larger than a height of the opening of the slide rail.

20. The pulley mounting structure according to claim 2, wherein in the working position, a distance between a lowest point of the pulley and a highest point of the limit part is larger than a height of the opening of the slide rail.
